(19) United States
(12) Patent Application Publication
(10) Pub. No.: US 2017/0151986 A1
(43) Pub. Date: Jun. 1, 2017

(54) PERFORMANCE IMPROVEMENTS RELATING TO TRACKED VEHICLES

(71) Applicant: Progressive IP Ltd., Hamilton (NZ)

(72) Inventor: Rodney Warwick SHARP, Ngaruawahia (NZ)

(21) Appl. No.: 15/363,258

(22) Filed: Nov. 29, 2016

(30) Foreign Application Priority Data
Nov. 30, 2015 (NZ) 714635

(51) Int. Cl. B62D 55/125; B62D 55/00; B62D 55/32

(52) U.S. Cl. CPC B62D 55/125; B62D 55/32; B62D 55/00

(57) ABSTRACT

The present invention is directed to modifications to driving flexible tracks, typically of the type used on small excavators and tractors. The present invention provides a second outer sprocket arrangement to engage with outer guard teeth on the track, these being present on a number of proprietary flexible track arrangements to act as an antifouling measure.

### FIELD OF INVENTION

The present invention relates to drive wheel assemblies such as commonly used for driving the tracks on tracked vehicles. In particular the present invention is directed for use where there are multiple parallel sets on inwardly directed teeth on the tracks, which interact with the drive wheel assembly.

### BACKGROUND DESCRIPTION

Many smaller excavators and tractors use a track drive system, rather than conventional wheels. Typically the tracks are made of a flexible resilient material such as synthetic rubbers and polymers.

While specific proprietary designs may differ, these resilient tracks (as we shall refer to them) typically have a first set of inwardly directed teeth which interact with a sprocket arrangement on the drive wheel assemblies (typically one on each side of the vehicle). The sprocket arrangements are typically a series of roller assemblies extending between two annular roller supports, and in which one of the roller supports is adapted to be attached to a central drive hub.

On many flexible tracks there is a second and outer set of teeth. These often interact with the outer annular roller support (depending on the design of the drive wheel assembly) so that the support acts as a guide to help keep the track sliding sideways off the drive wheel assembly during vigorous use.

In reality the second teeth set was introduced to help prevent fouling of the drive wheel and other guide wheels on the vehicle when it was turning. Essentially this outer set (which are not provided on all proprietary designs and not intended as drivable teeth) are effectively ‘guard teeth’. During turning operations, a portion of the track and wheel assembly rotates (slides) sideways as the vehicle rotates (particularly if rotating on the spot). If the ground is muddy or uneven, the side of the track and wheel assembly can act like a bulldozer blade and push earth and ground material to the side. This pressure can force dirt and foreign material in the guide and drive wheel regions where it can accelerate wear on the track and cause other problems as a consequence of fouling. The second outer teeth set was introduced as a barrier to such material getting forced between guide wheels and the track (typically the drive wheel assembly is elevated above the ground), hence their intended role as guard teeth.

In practice, it has been found that the torque from the drive wheel assembly, apart from normal wear, can also damage the inwardly directed drive teeth (the first set).

Operators can, through the way they operate, apply excessive force and damage teeth. Because the tracks are resilient, this is often unknown to the driver except by visual inspection or when a more catastrophic failure occurs—problematic in the middle of a job.

Once one tooth is damaged, successive teeth can easily become damaged (or torn away) in quick succession. This can be as quick as during a single session on the vehicle. When the driver first becomes aware of this, by slipping tracks or uncharacteristic response, the track is often so damaged that it needs replacement.

It would therefore be useful to propose a solution or alternative which reduces the impact of excessive torque from a drive wheel assembly on the teeth of a resilient track, and/or potentially extended the life of a track and especially a resilient track.

It is therefore an object of the present invention to address at least some of the above problems.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a track drive wheel assembly for attachment to a hub comprising a first annular support separated from a second annular support by a radially distributed plurality of primary roller assemblies, the arrangement defining a first sprocket arrangement;

there being a third annular support separated from said second annular support by a radially distributed plurality of secondary roller assemblies, the arrangement defining a second sprocket arrangement;
there being included retaining means to maintain the components in said first and second sprocket arrangements.

According to another aspect of the present invention there is provided a track drive wheel assembly for attachment to a hub, substantially as described above, in which the rotational axes of said first and second sprocket arrangements are substantially coaxial.

According to another aspect of the present invention there is provided a track drive wheel assembly for attachment to a hub, substantially as described above, in which said primary and secondary roller assemblies are substantially coaxial.

According to another aspect of the present invention there is provided a track drive wheel assembly for attachment to a hub, substantially as described above, in which a retaining means comprises one or more support shafts extending between said annular supports.

According to another aspect of the present invention there is provided a track drive wheel assembly for attachment to a hub, substantially as described above, in which either or both of a primary and secondary roller assembly can rotate about a retaining means comprising one or more support shafts.

According to another aspect of the present invention there is provided a track drive wheel assembly for attachment to a hub, substantially as described above, in which one or more support shafts passing through the centre of a primary roller assembly contributes to securing said first and second annular roller supports to each other.

According to another aspect of the present invention there is provided a track drive wheel assembly for attachment to a hub, substantially as described above, in which one or more support shafts passing through the centre of a primary roller assembly contributes to securing said first and second and third annular roller supports to each other.

According to another aspect of the present invention there is provided a track drive wheel assembly for attachment to a hub, substantially as described above, in which where there is a plurality of support shafts through the centre of a roller assembly, these support shafts are arranged and connected longitudinally.

According to another aspect of the present invention there is provided a track drive wheel assembly for attachment to a hub, substantially as described above, in which the rotational axes of said primary and secondary roller assemblies are coaxial.

According to another aspect of the present invention there is provided a track drive wheel assembly for attachment to a hub, substantially as described above, in which in which a said annular roller support is substantially an annular plate.

According to another aspect of the present invention there is provided a track drive wheel assembly for attachment to a hub, substantially as described above, in which the distance of separation of the annular roller supports corresponds to the width and spacing of the teeth on a track with which the track drive wheel assembly is to be used.

According to another aspect of the present invention there is provided a track drive wheel assembly for attachment to a hub, substantially as described above, in which at least two of said annular roller supports are positioned and configured to act as guides interacting with teeth on a track to restrict sideways movement of the track relative to the track drive wheel assembly.

According to another aspect of the present invention there is provided a method for modifying an existing track drive wheel comprising first and second annular roller supports, separated by a plurality of primary roller assemblies, to be modified to a track drive wheel substantially as described above by steps comprising:
i) securing a radially distributed set of secondary roller assemblies to the existing track drive wheel;
ii) affixing a third annular roller support thereto.

According to another aspect of the present invention there is provided a method, substantially as described above, in which the primary roller assemblies are secured in the existing track drive wheel assembly by a central primary bolt extending from the outside of the first annular roller support, through a said primary roller assembly, through the second annular roller support, and secured with a nut or equivalent threaded securing device, and wherein there are included steps of:
(a) removing the nut or equivalent threaded securing device;
(b) threading a secondary support shaft on to the exposed central primary bolt;
(c) assembling a rotating secondary roller arrangement thereover;
(d) securing the third annular with fastening devices to the secondary support shafts.

According to another aspect of the present invention there is provided a method, substantially as described above, in which the primary roller assemblies are secured in the existing track drive wheel assembly by a central primary bolt extending from the outside of the first annular roller support, through a said primary roller assembly, through the second annular roller support, and secured with a nut or equivalent threaded securing device, and wherein there are included steps of:
(a) removing the nut or equivalent threaded securing device;
(b) replacing the central primary bolt with a longer bolt;
(c) placing a hollow secondary support shaft over the extended bolt;
(d) assembling a rotating secondary roller arrangement thereover;
(e) securing the third annular roller support with nuts or equivalent fastening elements applied to said extended bolts.

According to a further aspect of the present invention there is provided a track drive wheel assembly comprising first and second sprocket sets for interacting with two parallel teeth sets of a track assembly, said first and second sprocket sets comprising primary and secondary roller assemblies respectively, and connecting annular roller drive supports which also act as guide wheels for said teeth on the track assembly.

According to yet a further aspect of the present invention there is provided a tractor unit with track assemblies, and including one or more track drive wheel assemblies substantially as described above.

In simple terms the present invention seeks to modify the design of the drive wheel assembly to address issues with track tooth damage. With the benefit of hindsight the present invention is relatively simple in concept, though it addresses a longstanding issue in a manner which none other (to the best knowledge of the applicant) has done.

Preferred embodiments of the present invention seek to use the second outer guard set of teeth on a track as drive teeth as well. This means that part of the torque from the drive wheel assembly is transmitted to these guard teeth, thereby reducing the effective torque load on the drive teeth for a specific applied torque by the wheel assembly. This potentially can reduce the likelihood of a drive tooth being sheared from the track. This can significantly extend the life of a track, as teeth become progressively more rapidly sheared or torn from a track as each successive drive tooth fails. Thus, preventing the first tooth failing can have a significant impact on track life.

Additionally, by better supporting the second outer teeth set in an additional sprocket assembly, the track can experience less shear in the plane where it contacts the ground during operations (such as turning on the spot) where the track is forced to slide sideways (often with a rotational component) across the ground. In simple terms, better support can result in less localized stress on the track, which has the potential to result in a longer life; a significant advantage.

The present invention either provides a drive wheel assembly or modifies an existing drive wheel assembly to implement the general concept of the present invention, and which shall be described as follows.

In a new drive wheel (which is the best example to explain the concept of the invention), there are present the traditional first and second annular roller supports which are connected by a radially distributed array of roller assemblies, called the primary roller set. These define a single sprocket arrangement, which we shall refer to as a first sprocket arrangement.

An extended length bolt or supporting shaft may pass through the primary roller assemblies to secure the components together. Typically one of the annular roller supports is adapted to secure the sprocket arrangement to a driving hub on the tractor unit, as per standard practice (which also allows retrofitting of the present invention to a proprietary tractor unit).

In the present invention there is also a further set of secondary roller assemblies, typically coaxial with the primary roller assemblies, which extend to a third annular roller support. These define a second sprocket arrangement, and are positioned and configured so that the sprocket can interact with the second (outer) tooth set on a track.

The same bolts as used in the first sprocket arrangement can secure the secondary roller assemblies and third annular roller support. An outer nut or similar fastening element can hold everything together. The supporting shafts may comprise more than one longitudinally connected shaft or bolt. In one preferred example for modifying an existing proprietary unit, extended length nuts which secure to the threaded end of existing proprietary bolts (for retaining the first socket arrangement) can pass through the secondary roller assemblies to both support them and retain the third annular roller support. Variations of these principles are envisaged and within the scope of the present invention.

As mentioned above, the resulting drive wheel assembly is typically adapted to secure to an existing drive hub, and this may be accomplished by use of a modified central second annular roller support.

The length of the primary and secondary rollers (and hence distance of separation of the annular roller supports, are typically determined by the size and spacing of the teeth on the track.

Variations exist. The annular supports could be disc-like (rather than sprocket like in front view), though this generally adds unwanted weight and obscures vision for visual inspection.

Additional roller assembly sets and annular roller supports could be added for tracks with more than two sets of teeth.

Another aspect of the invention is to modify an existing drive wheel assembly. These typically comprise the first and second annular supports and primary rollers set, with securing bolts passing therethrough to be secured by nuts on the outside of the second annular support.

While longer bolts can be provided (which would likely necessitate removing the drive wheel from the hub), an alternative solution is to thread secondary support shafts to the extending bolts to replace the nut. Various locking techniques, from spring and lock washers through to chemically bonding agents such as the ubiquitous Loctite® type of products, can be employed as desired. The secondary rollers can be fitted over the secondary support shafts, and the third annular roller support secured by bolts into the secondary support shafts, or a mechanically equivalent alternative.

This arrangement can allow for an existing drive wheel assembly to be readily modified in situ.

### DESCRIPTION OF DRAWINGS

FIG. 1 is a perspective diagrammatic view of a preferred embodiment of the present invention;

FIG. 2 is a side diagrammatic view of the embodiment of FIG. 1, and

FIG. 3 is a cross-sectional view of the same embodiment.

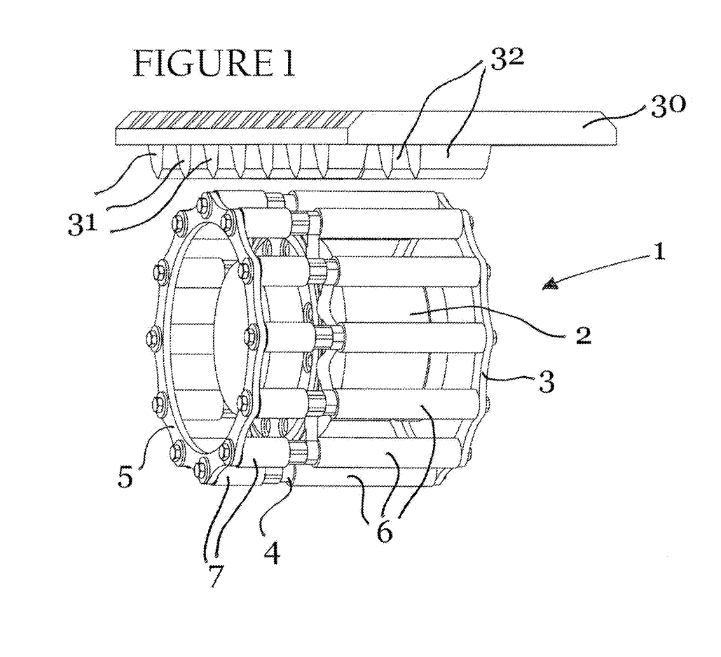

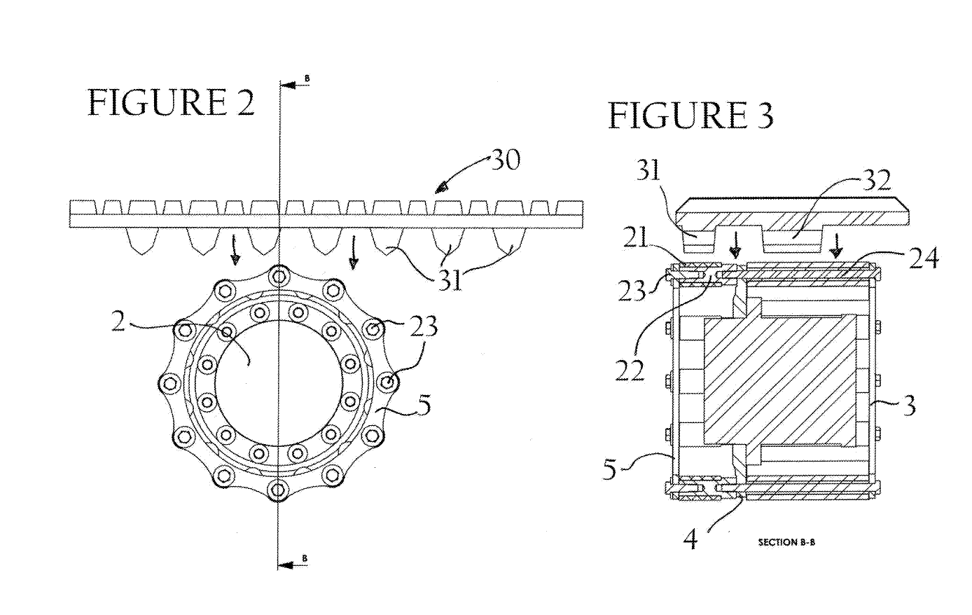

### DESCRIPTION OF PREFERRED EMBODIMENT

According to one aspect of the present invention, and with reference to the drawings, there is provided a track drive wheel assembly (generally indicated by arrow 1) for attachment to a hub (2).

The wheel assembly (1) comprises a first annular support (3) separated from a second annular support (4) by a radially distributed set of primary roller assemblies (6). Known wheel sets are generally constructed this way and form a first sprocket arrangement for engaging the first inner set of teeth (32) on a track, but not the outer tooth set (31)—these teeth in the prior art act primarily as a guard for reducing the amount of ground material finding its way into the sprocket roller assemblies (6).

According to this described embodiment a third annular support (5) is provided and separated from the second annular support (4) by a set of secondary roller assemblies comprising a roller (21) over a support shaft (22). In a wheel set manufactured from scratch the primary roller securing bolt (24) can extend all the way through to the outside of third annular ring (5). In the illustrated embodiment, an embodiment comprising a modified wheel set (1) is illustrated (see in particular FIG. 3). The support shaft (22) is threaded onto the end of primary securing bolt (24) after its nut (not shown) is removed. Loctite® or a comparable securing compound may be employed. The roller (21) and any optional washers or packers are slid over the shaft (22) and an outer securing bolt (23) inserted and tightened to secure the secondary roller assemblies (7).

FIG. 3 clearly illustrates the resulting double sprocket arrangement which engages both teeth sets (31, 32) and more accurately guiding the track with respect to the wheel set assembly (1).

Aspects of the present invention have been described by way of example only and it should be appreciated that modifications and additions may be made thereto without departing from the spirit or scope of the present invention as described herein.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention.

1. A track drive wheel assembly for attachment to a hub comprising a first annular support separated from a second annular support by a radially distributed plurality of primary roller assemblies, the arrangement defining a first sprocket arrangement;
there being a third annular support separated from said second annular support by a radially distributed plurality of secondary roller assemblies, the arrangement defining a second sprocket arrangement;
there being included retaining means to maintain the components in said first and second sprocket arrangements.

2. A track drive wheel assembly as claimed in claim 1 in which the rotational axes of said first and second sprocket arrangements are substantially coaxial.

3. A track drive wheel assembly as claimed in claim 1 in which said primary and secondary roller assemblies are substantially coaxial.

4. A track drive wheel assembly as claimed in claim 1 in which a retaining means comprises one or more support shafts extending between said annular supports.

5. A track drive wheel assembly as claimed in claim 4 in which either or both of a primary and secondary roller assembly can rotate about a retaining means comprising one or more support shafts.

6. A track drive wheel assembly as claimed in claim 4 in which one or more support shafts passing through the centre of a primary roller assembly contributes to securing said first and second annular roller supports to each other.

7. A track drive wheel assembly as claimed in claim 4 in which one or more support shafts passing through the centre of a primary roller assembly contributes to securing said first and second and third annular roller supports to each other.

8. A track drive wheel assembly as claimed in claim 6 in which where there is a plurality of support shafts through the centre of a roller assembly, these support shafts are arranged and connected longitudinally.

9. A track drive wheel assembly as claimed in claim 5 in which the rotational axes of said primary and secondary roller assemblies are coaxial.

10. A track drive wheel assembly as claimed in claim 1 in which in which a said annular roller support is substantially an annular plate.

11. A track drive wheel assembly as claimed in claim 1 in which the distance of separation of the annular roller supports corresponds to the width and spacing of the teeth on a track with which the track drive wheel assembly is to be used.

12. A track drive wheel assembly as claimed in claim 1 in which at least two of said annular roller supports are positioned and configured to act as guides interacting with teeth on a track to restrict sideways movement of the track relative to the track drive wheel assembly.

13. A method for modifying an existing track drive wheel comprising first and second annular roller supports, separated by a plurality of primary roller assemblies, to a track drive wheel as claimed in claim 1, said method comprising steps:
i) securing a radially distributed set of secondary roller assemblies to the existing track drive wheel;
ii) affixing a third annular roller support thereto.

14. A method for modifying an existing track drive wheel as claimed in claim 13 in which the primary roller assemblies are secured in the existing track drive wheel assembly by a central primary bolt extending from the outside of the first annular roller support, through a said primary roller assembly, through the second annular roller support, and secured with a nut or equivalent threaded securing device, and wherein there are included steps of:
(a) removing the nut or equivalent threaded securing device;
(b) threading a secondary support shaft on to the exposed central primary bolt;
(c) assembling a rotating secondary roller arrangement thereover;
(d) securing the third annular with fastening devices to the secondary support shafts.

15. A method as claimed in claim 14 in which the primary roller assemblies are secured in the existing track drive wheel assembly by a central primary bolt extending from the outside of the first annular roller support, through a said primary roller assembly, through the second annular roller support, and secured with a nut or equivalent threaded securing device, and wherein there are included steps of:
(a) removing the nut or equivalent threaded securing device;
(b) replacing the central primary bolt with a longer bolt;
(c) placing a hollow secondary support shaft over the extended bolt;
(d) assembling a rotating secondary roller arrangement thereover;
(e) securing the third annular roller support with nuts or equivalent fastening elements applied to said extended bolts.

16. A tractor unit with track assemblies, and including one or more track drive wheel assemblies as claimed in claim 1.
